(19) United States
(12) Patent Application Publication
(10) Pub. No.: US 2005/0130734 A1
(43) Pub. Date: Jun. 16, 2005

(54) Method and system for operating a random drawing game

(76) Inventors: Ondine Khayat, Paris (FR); Frederic Koskas, Paris (FR)

Correspondence Address: AKERMAN SENTERFITT, P.O. BOX 3188, WEST PALM BEACH, FL, 33402-3188, US

(21) Appl. No.: 10/506,303

(22) PCT Filed: Mar. 1, 2002
(86) PCT No.: PCT/FR02/00750

(51) Int. Cl. A63F 13/00; G06F 19/00; G06F 17/00

(52) U.S. Cl. 463/22

(57) ABSTRACT

This is a matter of drawing a universal series {ek} of p distinct characters ek from a set En of n characters {ek}. Players input personal series of p distinct characters {Sk} which are collected and stored and p successive elementary draws are carried out, each of a first and of a single character ek, from p sets respectively each formed of n characters without those drawn in all the previous elementary draws ek.

The system includes means for inputting, collecting and storing the series of characters (18, 20) and for game entry (19), these means being connected to an operational control centre (100). Means (105, 15) for commanding the removal of characters are also provided.

### CROSS-REFERENCE TO RELATED APPLICATIONS

This application forms the national phase of PCT/FR02/00750, filed Mar. 1, 2002.

### BACKGROUND OF THE INVENTION

Lottery games are games of chance in which the players obtain a gaming grid of n characters, generally numbers, to which correspond numbered balls, for example. After having selected on his grid of n numbers an arrangement of p of these numbers, each player validates his selection on a game terminal. Any series of these p distinct objects arbitrarily chosen from n objects is called an arrangement of these n objects, taken p by p without repetition. A series of objects is a collection of objects arranged in a specific order. Then, in a drawing centre having a container containing the balls which are being mixed together, p are randomly removed therefrom to constitute a winning arrangement.

The operation of such a game does not pose too many difficulties and many—not to say all—countries offer this type of lottery to their inhabitants. After having collected all the arrangements played and having determined the number of winners, the prize, a priori a pecuniary prize, merely has to be distributed between the winners. The operation thus essentially requires game terminals able to validate the game grids and to detect a winning grid, and a controller able to determine the number of players and the number of winners.

Rendering this game of chance universal, whereas it has previously been exclusively national, has given the Applicants the idea of proposing a universal manner of operating it.

Thus the invention firstly relates to a process for operating a game involving the random drawing of a universal series of p distinct characters from a set of n characters, wherein players input personal series of p distinct characters which are collected and stored and the drawing of the universal series is carried out by p successive elementary draws, each of a first and of a single character, from p sets respectively each formed originally of n characters but from which the characters drawn in all the previous elementary draws have been removed.

Of course, it is necessary to await the final draw to discover if a winning series has been selected.

However, the applicants are naturally not herein seeking to protect any rule for a new game.

The object for which protection is sought essentially relates to the steps of communicating to each elementary drawing centre the characters drawn in the other drawing centers as well as the steps of removing the characters previously drawn.

In one particular implementation of the process of the invention the removal of a character is carried out in real time after each elementary draw. However, it would also be possible, before each elementary draw, fully to remove all the characters previously drawn.

In one interesting implementation of the process of the invention, the players input their personal series of characters at spatially offset places.

In the preferred implementation of the process of the invention the elementary draws are carried out in a series of p different locations dispersed over the surface of the earth and everywhere substantially at the same local time.

The invention also relates to a process for operating a game involving the random drawing of a universal series of p distinct characters from a set of n characters, wherein players input personal series of p distinct characters which are collected and stored and the drawing of the universal series is carried out by p successive elementary draws, each of a single character from a set formed originally of n characters but from which the characters drawn in all the previous elementary draws have been removed, the draws being carried out in a single place but at different times corresponding to predetermined local times of p different locations dispersed over the surface of the earth, the result of each draw being communicated in real time to the corresponding location.

The invention also relates to an operating system for implementation of the process of the invention comprising:
means for inputting the series of characters and for game entry,
means for collecting the series of characters,
means for storing the series of characters,
an operational control centre to which the collection means and the storage means are connected,
means for commanding the removal of characters from the sets of characters of drawing centers,
computing means of the operational control centre to determine the number of winners of the game as well as the prize to be distributed between them and thus the shares to be paid to them and
means for paying these shares.

The input means can cause to include [sic] consoles connected to the operational centre by a computer network.

They may also be telephone terminals or computer terminals connected to a call centre of the operational control centre.

The means for commanding the removal of characters maybe arranged to remove the characters in real time as they are drawn. However, they can also be arranged in order, before each draw, to remove fully and at a deferred time all the characters previously drawn.

The means for commanding the removal of characters can be centralized in the operational control centre; they can also comprise, in each drawing centre, means for reception of the characters drawn in the other drawing centers, to be removed locally, and for transmission of the locally drawn character to the other drawing centers.

In the case of elementary draws in a single place for different locations, the operating system must also comprise programmable timing means and means for transmitting data from the place of drawing to the locations.

The invention will be better understood with the aid of the following description of a particular implementation of the process and of an embodiment of the system in accordance with the invention in the light of the attached drawing in which:

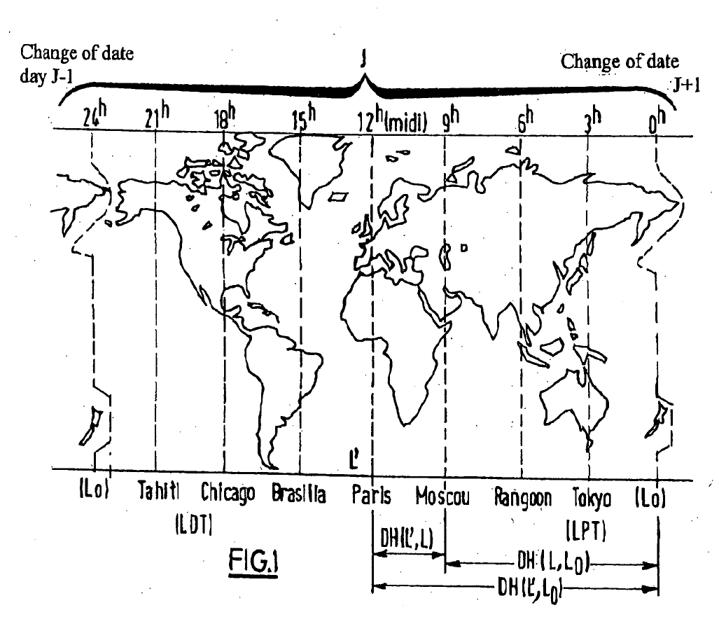

FIG. 1 illustrates the field of application of the process of the invention.

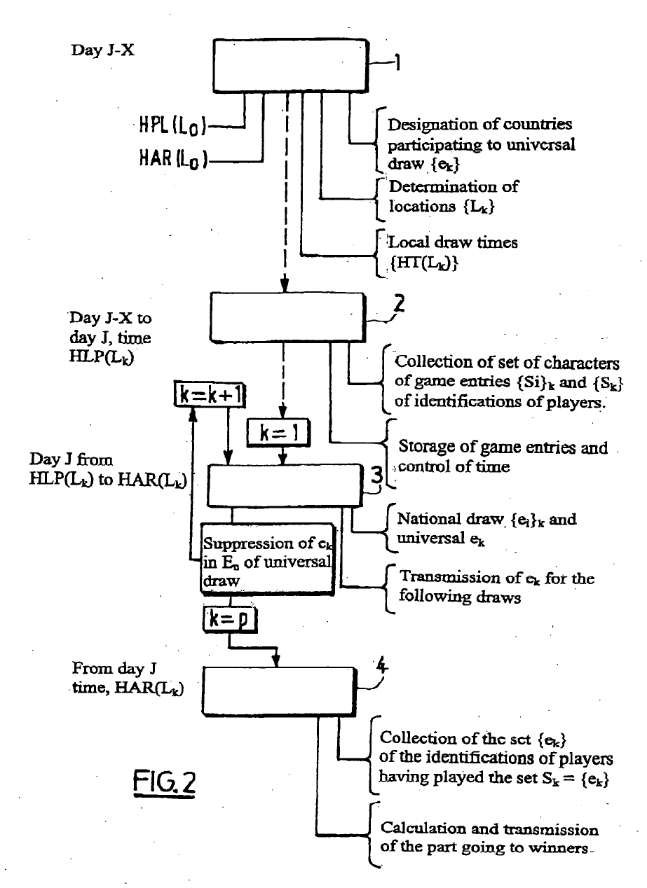

FIG. 2 illustrates the general operating process of the drawing game in accordance with the invention.

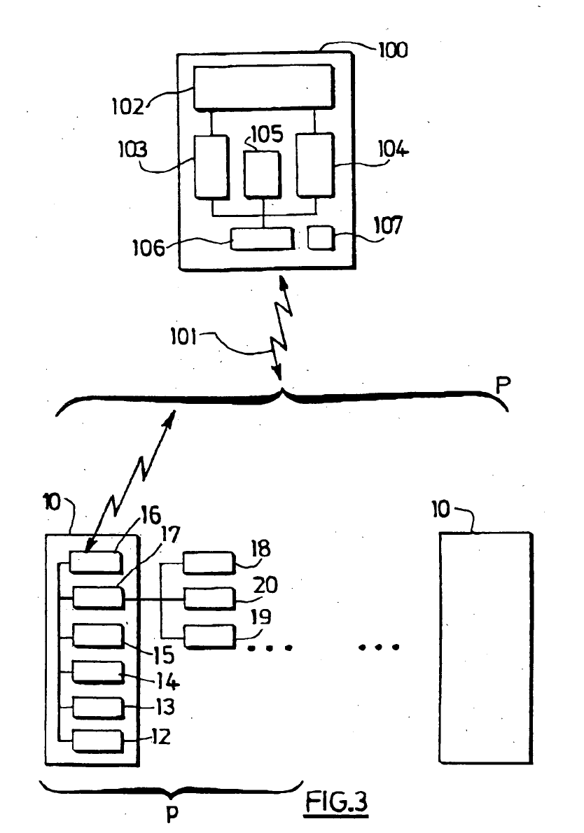

FIG. 3 illustrates a functional block diagram of the system in accordance with the invention.

With reference to FIG. 1 any inhabitant of the Earth can be a player participating in a game involving the random drawing of a set {ek} of p distinct characters ek numbered in this case 1 to p by the integer k, the set being designated by universal series {ek} in a set En={ej} of n distinct characters ej, following the example of the individuals of a given country participating in the national lottery game of that country. In order to do this the national lottery games effect a national random draw K of a series of p stored and collected characters {ei}k, i being an integer taking its values from the set {1, . . . , p}, characters from the set En, and, in accordance with the invention, effect the drawing of a supplementary character ek, which is also collected and stored, from this same set En, modified to form a supplementary series {ek}, a so-called universal series, in storage means, k taking its integer values from the set {1, . . . , p}.

It is clear that it is necessary to cause p countries to take part in the drawing of the universal series in order to obtain the complete universal series {ek}.

Furthermore, as it is desired that the series {ek} be formed according to the same laws of statistics as the series {ei} from the draws K of each country it is necessary to cause these p countries to participate successively and to cause these successive random draws of the characters ek to be carried out from p sets En each formed from the n characters ej, but from which—and this is the modification mentioned above—the previously drawn characters e₁ . . . eₖ₋₁ have been removed.

Thus a random draw of p characters from n characters has been reconstituted without repetition, thus by continuing to comply with the statistical laws usually applied to the ordinary lottery game.

FIG. 1 shows an example of p countries participating in such a draw {ek}, drawn at random sufficiently in advance to permit the draws to be organized.

In fact, since the national lottery draws are public, at specific dates and times, in particular at similar local times, if it is desired to draw the supplementary character ek in each country participating in the universal draw at the same time as the draws K of the series {ei}k, it is important to organize the implementation of the random draws over 24 hours and in particular to determine, —according to the places LPT of the first draw and LDT of the last draw, the limit dates and times at which players can enter the game and at which the results are to be given. Time is to be understood as the civil time of the place in question, i.e. the mean solar time increased by 12 hours.

In the rest of this description only local civil times will be considered which we refer to as H(L), civil time of the place L.

Thus the civil times H(L) and H(L′) in two locations L and L′ between which there is a time difference DH(L′, L) correspond to the same moment in universal time provided that:
H(L′)=H(L)−DH(L′, L) (1)
By this formula it is possible to determine the limit civil times defined by the places LPT and LDT for any point on the globe.

Hereinunder it has been found convenient to assimilate the dateline meridian at a particular drawing place LO.

Thus H(LO) can serve as a reference to determine all the time differences of N locations with respect to each other throughout the world without resorting to more than N data of the DH(L, LO) type since:
DH(L′, L)=DH(L′, LO)−DH(L, LO) (2)

Of course, it would have been possible to limit oneself to a simplified process in which the limit dates and times H(LPT) and H(LJDT) would be fixed in advance. However, if for example in all the participating countries drawn by lots are located in a single time zone the process proposed presents the advantage of shortening the time required to await the result of the draw and of extending the time during which the player can participate in the game. In this limit example all the draws in effect take place practically at the same time.

In the example of FIG. 1 7 cities, also dispersed over the earth, have been chosen, the first location being Tokyo, place of the first draw (LPT), and the last location being Tahiti (LDT). The example of FIG. 1 makes it possible, on the other hand, to show the two fundamental differences between the random universal draw of the invention and the random national draw: the duration of the draw can be 24 hours and the draw is broken up geographically.

Hereinunder, with reference to FIG. 2, the process comprises the following steps.

In a first initial step 1, the day J-X, J being the day of the universal draw, X being specified in advance in order to organize the universal draw, the p countries are designated from among the candidate countries, for example they are drawn by lots. This step makes it possible to determine the locations (Lk) of the supplementary draws ek by longitude and latitude as well as limit times for participation in the game HLP(Lk) at any place Lk dependent on the time H(LPT)=H(L1) of the first draw and the time of the last draw or presentation of the results of the draws HAR(Lk) depending on the time H(LDT)=H(Lp) of the last draw. These times are calculated by applying formulas (1) and (2).

Thus in the example of FIG. 1 a minimum of 18 hours passes between HLP and HAR but the draws effected at L1 and Lp take place substantially at the same local time.

The similarity of the local times may possibly not be respected. This is why the process in step 1, in its most complete version, includes taking account of the local times of the draws organized by the designated countries. Hereinunder these local draw times are referenced HT(Lk), Lk designating the location of the draw K, in this case the longitude of the place.

In a second step 2, still with reference to FIG. 2, the collection is carried out, until the time HLP of the day J, of the set of game entries {Si}k and {Sk} on the series {ei}k and {ek}, effected by the players of all the countries, either participating or not, until the date J and the limit time, in this case for {ek}, HLP. These data and possibly others, in particular for the identification of the players, are stored.

In a third step 3 the national draws {ei}k and universal draws {ek} are carried out successively from the first country to the p^{th} country in the usual manner of drawing the lottery for each national draw, i.e. from a set En of characters, and in such a way as to draw only one character ek, in the designated countries, from a set E₍ₙ₋ₖ₊₁₎ of characters which is different from the set En by the fact that E₍ₙ₋ₖ₊₁₎ is obtained from En while removing the previously drawn characters e₁, . . . eₖ₋₁.

In a final step 4, the series {ek} is collected, the references associated with the series Sk equal to the series {ek}, the share is calculated according to the prize to be distributed and to the number of wins, and the winning series and the share of the national draw are transmitted in order to credit the winners therewith, for example in the normal manner used by the national draw organizations.

In order to implement the process the system includes, with reference to FIG. 3, an operational control centre 100 connected to national random drawing centers 10.

The operational control centre 100 is essentially composed of command means 105 to control the universal draw in order to control in particular the removal, from the sets En, of the characters ek already drawn.

It also comprises means 103 for determining periods of time validity of the game entries and for indication of the results, computing means 104 to determine the total number of winners of the universal game as well as the prize to be shared and thus the shares to be paid to the winners, and finally storage means 102 to store the data which are useful for organizing and controlling the universal draws.

It is connected to the national drawing centers 10 by a communication interface means 106 connected (101) by radio satellite or other means to the means 16. This connection could equally well be produced by normal telephone cable or could borrow a dedicated computer network or the Internet using a protected link.

The national game centers 10, apart from their ordinary game installations, their game entry input means 10 and means 18 for collecting the series of characters and their means 20 for effecting the random draw, have a microprocessor 17 for controlling the various input and drawing means and to process the requirements of the operational control centre 100, the storage means 12 and the communication interface means 16 in order to communicate with the operational centre.

The national centers 10 further comprise means 13 to manage the games, to check the time and location validity of the input games and to search the list of winning games stored in the storage means 12 once the draw is over, means 14 for broadcasting the results of draws, for example, via the Internet and command means 15 for the universal draw so as to command the removal from the set En of characters ek already drawn.

The input means 19 can also be formed, for example, from Internet sites accessible to the players. The said Internet sites can also be accessible via mobile telephone, the place and time of game entry being authenticated by the mobile telephone network to which the telephone is connected, and the identification of the player being provided by the number of his line and his references registered by the operator of the mobile telephone network.

The means 18 for collecting the series of characters can be the ordinary national means used for the random draw and for inputting of the draws effected in order to broadcast them at the current time. However, they can also be composed of automatic optical input means for the draws carried out, for example by optical reading of bar codes suitably affixed to the random draw means.

The operation of the system will now be described.

The operational control centre 100 completely carries out step 1 of the process described above.

Its command means 105:
1) seek, within the storage means 102, the list of the countries likely to carry out a random draw on the selected day J;
2) randomly draw p countries from this list to obtain a list of designated countries and the location Lk of the place where they make their draw; and
3) sort the list in the sense of the values Lk presenting increasing time differences with respect to the dateline meridian LO. These means 103 for determining the periods of validity:
   1) acquire from the national centers 10 concerned the drawing times, HT(L1) to HT(Lp) for the day J, Li being the longitude of the place where the draw is carried out having the least time difference and Lp having the greatest time difference with respect to LO, these times previously stored in the storage means 12 or 102; and
   2) determine HLP(LO) and HAR(LO) by the following calculation
      HLP(LO)=HT(L1)+DR(L1, LO) (3)
      HAR(LO)=HT(Lp)+DH(Lp, LO) (4)
      L1 and Lp being removed from the list drawn by the means 105.

At least the national centers 10 of the p countries designated are thus requested by the connection 101 and by the interface means 106 and 16 to organize, for the time HT(Lk) of the day J, the drawing of the character ek. On this occasion the parameters HLP(LO) and HAIR(LO) are transmitted to the national centers 10. From then the national centers carry out step 2 of the process described above until the time HLP(Lk) calculated from HLP(LO) according to formula (1) by the means 15 for commanding the draw. In particular, the microprocessor 17 activates the input means 19 for the game entries and retrieves the set {Sk} of the series Sk proposed by the players using these means in order to store them, with the references of the players, in the storage means 12 after checking the validity, which is carried out by the management means 13, of the date and time of the game entry with respect to the time HLP(Lk).

On the day J, at the time HT(Lk), the command means 105 issue a message agreeing to the drawing of a character ek by the national centre 10 in the location Lk, this message also including the elements e1 . . . e(k−1) previously drawn. This message is transmitted via the means 106, 101, 16 to the command means 15 which remove the elements transmitted in the set En used by the random drawing means 20, then initiate the drawing of ek. The character ek obtained is then collected by the means 18 for collecting the series of characters, transmitted to the microprocessor 17 then via the connection 101 to the command means 105 which store it in the storage means 102 in order to be able to issue the message of agreement to the drawing of the following character e(k+1), and to reconstitute the winning series {ek} of characters when the p draws have been effected.

It will be noted that it is not necessary for the transmission of the characters ek, which are to be removed in the other national centers 10, to pass via the operational centre 100. It may be direct via the radio connection 100 or, for example, via the computer network. In this case the characters are removed in real time.

The winning series is communicated to all the national centers 10 which, by their validity-checking means 19, draw up the list of winners, count them and transmit them with the number of players to the operational centre which establishes, by its computing means 104, the share to be distributed and returns the result to the centers 10 for redistribution.

Of course, if the operational centre is located in one place LC it is possible to implement the operation of the universal game entirely at this place and to carry out there the p elementary draws at times corresponding to the draw times HT(Lk) of the p participating countries. In this case the times HTk of the p draws are given by the formula (1) which can be rewritten:
HTk(LC)=HT(Lk)−DH(LC,Lk)
The process remains identical but implementation is greatly simplified by the fact that the removal of the characters already drawn e₁ . . . eₖ₋₁ at the time of implementation of the draw k is carried out on the same set En by the actual fact of the co-location of the draws. On the other hand, timing means 107 and random drawing means 108 need to be provided within the operational centre, being capable of ensuring the random draws at times HT(LC) calculated by the means 105 unless these draws are effected at a place already equipped with a national drawing centre. The results of the draw are thus sent to the national centers 10 at these same times, substituting for the agreement messages issued by the means 105.

In this version the national centers can be completely distinct from the operational centre provided that this centre is equipped with means for inputting game entries, for example a computer messaging server connected to a computer network of the Internet type or a call centre connected to a mobile telephone network, in which case the server or the call centre has means for authentication of the places and times of the game entry and for checking their validity following the example of the means 13 of the national centers.

1. Process for operating a game involving the random drawing of a universal series ({ek}) of p distinct characters (ek) from a set (En) of n characters ({ek}), wherein players input personal series of p distinct characters ({Sk)) which are collected and stored and the drawing of the universal series is carried out by p successive elementary draws, each of a first and of a single character (ek), from p sets respectively each formed originally of n characters but from which the characters drawn in all the previous elementary draws (ek) have been removed.

2. Process as claimed in claim 1, wherein the removal of a character (ek) is carried out in real time after each elementary draw.

3. Process as claimed in claim 1, wherein before each elementary draw all the (k−1) characters previously drawn are fully removed.

4. Process as claimed claim 1, wherein the players input their personal series (Sk) of characters at spatially offset places (Lk).

5. Process as claimed in claim 1, wherein the elementary draws are carried out in a series of p different locations (Lk) dispersed over the surface of the earth and everywhere substantially at the same local time HT of the place (Lk).

6. Process for operating a game involving the random drawing of a universal series of p distinct characters from a set of n characters, wherein players input personal series of p distinct characters which are collected and stored and the drawing of the universal series is carried out by p successive elementary draws, each of a single character from a set formed originally of n characters but from which the characters drawn in all the previous elementary draws have been removed, the draws being carried out in a single place (LC) but at different times HTk of the place (LC) corresponding to predetermined local times (HT(Lk) of p different locations (Lk) dispersed over the surface of the earth, the result of each draw being communicated in real time to the corresponding location Lk.

7. Operating system for implementation of the process of the invention comprising:
means for inputting the series of characters and for game entry (19),
means for collecting the series of characters (18, 20),
means for storing the series of characters 12, 102),
an operational contrs centre (100) to which the collection means and the storage means are connected,
means for commanding the removal (105, 15) of characters ek from the sets En of characters of drawing centers,
computing means (14, 104) of the operational control centre to determine the number of winners of the game as well as the prize to be distributed between them and thus the shares t o be paid to them and
means for paying these shares (14).

8. System as claimed in claim 7, wherein the input means include consoles connected to the operational centre by a computer network.

9. System as claimed in claim 7, wherein terminals are provided connected to a call centre of the operational control centre.

10. System as claimed in claim 7, wherein the means for commanding the removal of characters are arranged to remove the characters in real time as they are drawn.

11. System as claimed in claim 7, wherein the means for commanding the removal of characters are arranged in order, before each draw, to remove fully and at a deferred time all the characters previously drawn.

12. System as claimed in claim 7, wherein the means for commanding the removal of characters are centralized in the operational control centre.

13. System as claimed in claim 7, wherein the means for commanding the removal of characters comprise, in each drawing centre (10), means (16) for reception of the characters (ek) drawn in the other drawing centers (10), to be removed locally, and for transmission of the locally drawn character to the other drawing centers.

14. System as claimed in claim 7, wherein in the case of elementary draws in a single place for different locations, programmable timing means (107) and means for transmitting data from the place of drawing to the locations are provided.
